(19) United States
(12) Patent Application Publication
(10) Pub. No.: US 2007/0175769 A1
(43) Pub. Date: Aug. 2, 2007

(54) Potentiometric pCO2 Sensor and the Fabrication Method thereof

(75) Inventors: Shen-Kan Hsiung, Tao-Yuan (TW); Jung-Chuan Chou, Tao-Yuan (TW); Tai-Ping Sun, Tao-Yuan (TW); Nien-Hsuan Chou, Tao-Yuan (TW); Szu-Ping Chen, Tao-Yuan (TW)

Correspondence Address: WPAT, PC, 7225 BEVERLY ST., ANNANDALE, VA, 22003, US

(73) Assignee: CHUNG YUAN CHRISTIAN UNIVERSITY, Tao-Yuan (TW)

(21) Appl. No.: 11/458,100

(22) Filed: Jul. 18, 2006

(30) Foreign Application Priority Data
Jan. 27, 2006 (TW) 095103445

(51) Int. Cl. G01F 1/64; G01N 27/26

(52) U.S. Cl. 205/784; 204/424

(57) ABSTRACT

This invention provides a pCO₂ sensor, and more particularly, a potentiometric pCO₂ sensor. The potentiometric pCO₂ sensor has a substrate, a solid ion-sensing layer on the substrate, a solid electrolyte layer on the solid ion-sensing layer, and a gas-permeable layer on the solid electrolyte layer. In addition, the gas-permeable layer allows air molecules to diffuse through, the solid electrolyte layer change the pH value thereof according to the CO₂ concentration in the diffusing air molecules, and the solid ion-sensing layer senses the pH change of the solid electrolyte layer to generate a sensing signal. By doing so, the quantity of the CO₂ dissolved in the liquid can be measured.

### BACKGROUND OF THE INVENTION

1. Field of the Invention

The present invention is generally related to a pCO₂ sensor and the fabrication method thereof, and more particularly, a potentiometric pCO₂ sensor for sensing the CO₂ concentration in a liquid and the fabrication method thereof.

2. Description of the Prior Art

At present, the electronic technology has tremendous progress. Furthermore the technology of the biochemical device has been applied to the design of sensors. In clinical diagnosis, partial pressure of carbon dioxide (pCO₂) is an important index in observation of ventilator dependent patients. The relationship of the partial pressure and the concentration of carbon dioxide exists a nature coefficient. Usually, the partial pressure of carbon dioxide multiplied by 0.03 is the concentration of carbon dioxide. In medicine, the required measurement range for human beings is between 1 mmol/l (mM) and 3 mmol/l (mM). In general, the normal value for the partial pressure of carbon dioxide is ca. 35 mmHg˜45 mmHg. If the partial pressure of carbon dioxide is lower than 35 mmHg and the pH value is higher than 7.5 in the blood, it may indicate respiratory alkalosis. If the partial pressure of carbon dioxide is higher than 45 mmHg and the pH value is smaller than 7.35 in the blood, it may indicate respiratory acidosis. If the partial pressure of carbon dioxide is higher than 50 mmHg, respiratory exhaustion may be present and proper treatment will be required immediately. If the partial pressure of carbon dioxide is higher than 70 mmHg, especially for the case of drastically increase, it will result in a coma. Therefore, the measurement of the partial pressure of carbon dioxide is very important in clinical diagnosis.

The method for analyzing carbon dioxide includes optical, current, and potentiometric types. Among these, the potentiometric type has simpler structure than the other two. The potentiometric type generally detects the pH change of the inner buffer solution so as to detect the concentration of carbon dioxide. (M. E. Meyehoff, Y. M. Fraticelli, J. A. Greengerg, J. Rosen, S. J. Parks, and W. N. Opdycke, “Polymer-membrane electrode-based potentiometric sensing of ammonia and carbon dioxide in physiological fluids”, Clinical Chemistry, Vol. 28 pp. 1973-1978, 1982.; E. J. Fogt, D. F. Untereker, M. S. Norenberg, and M. E. Meyerhoff, “Response of Ion-selective field effect transistors to carbon dioxide”, Analytical Chemistry, Vol. 57 pp. 1995-1998, 1985.; M. E. Collison, G. V. Aebli, J. Petty, and M. E. Meyerhoff, “Potentiometric combination ion/carbon dioxide sensors for in vitro and in vivo blood measurements”, Analytical Chemistry, Vol. 61 pp. 2365-2372, 1989.) In a conventional pCO₂ sensor, the sensing electrode is based on the pH glass electrode. However, the disadvantage of using the pH glass electrode is voluminous, hard to preserve, and high-cost. That is, the pCO₂ sensor using the pH glass electrode also has the disadvantage of voluminous, hard to preserve, and high-cost. Besides, the pCO₂ sensor requires dichromate solution that needs to be replaced regularly to avoid deterioration of the solution. The outermost gas-permeable film of the pCO₂ sensor is also consumable.

The present invention is based on the acid-base ion selective electrode and utilizes the characteristics of the gas-permeable film allowing air molecules to diffuse through and the pH value of the solid electrolyte layer changing in response to the CO₂ concentration in the diffusing air molecules to fabricate the pCO₂ sensor for detecting the CO₂ concentration in a liquid. In comparison with the conventional pCO₂ sensor, the solid-state-type pCO₂ sensor made by using polymer technology and semi-conducting processes does not require dichromate solution and buffer solution. The process of filling the dichromate solution is not necessary as well as replacing the buffer solution regularly. The solid-state-type pCO₂ sensor also has simple structure. Thus, the required volume is reduced as well as the fabrication cost. Therefore, it is suitable for manufacturing in quantity and easy for preservation. The solid-state-type pCO₂ sensor also has conveniences in carrying and lower cost, compared to the conventional one.

### SUMMARY OF THE INVENTION

In accordance with the present invention, a potentiometric pCO₂ sensor is provided. The potentiometric pCO₂ sensor comprises a substrate; a solid ion-sensing layer on the substrate; a solid electrolyte layer on the solid ion-sensing layer; and a gas-permeable layer on the solid electrolyte layer; wherein the gas-permeable layer allows air molecules to diffuse through, the pH value of the solid electrolyte layer changes in response to the CO₂ concentration in the diffusing air molecules, and the solid ion-sensing layer senses the pH change of the solid electrolyte layer to generate a sensing signal so as to detect the CO₂ concentration in a liquid.

The present invention further discloses a method for fabricating a potentiometric pCO₂ sensor comprising the following steps: depositing a solid ion-sensing layer on a substrate; connecting a conducting wire to the solid ion-sensing layer; performing a sealing process to form a sealing layer enclosing the peripheral of the substrate and the solid ion-sensing layer and cover the top of the substrate and the solid ion-sensing layer wherein the sealing layer has a window to expose part of the solid ion-sensing layer; forming a solid electrolyte layer on the solid ion-sensing layer; and forming a gas-permeable layer on the solid electrolyte layer; wherein the gas-permeable layer allows air molecules to diffuse through, the pH value of the solid electrolyte layer changes in response to the CO₂ concentration in the diffusing air molecules, the solid ion-sensing layer senses the pH change of the solid electrolyte layer to generate a sensing signal, and the sensing signal is outputted by the conducting wire so as to detect the CO₂ concentration in a liquid.

### BRIEF DESCRIPTION OF THE DRAWINGS

FIG. 1A is a schematic diagram illustrating part of fabrication steps and sectional structure of the potentiometric pCO₂ sensor in a preferred embodiment of the present invention;

FIG. 1B is a schematic diagram illustrating part of fabrication steps and sectional structure of the potentiometric pCO₂ sensor in a preferred embodiment of the present invention, based on FIG. 1A;

FIG. 1C is a schematic diagram illustrating part of fabrication steps and sectional structure of the potentiometric pCO₂ sensor in a preferred embodiment of the present invention, based on FIG. 1B;

FIG. 2 is a schematic system block diagram illustrating the measurement by the potentiometric pCO₂ sensor in a preferred embodiment of the present invention;

FIG. 3 is a characteristic curve of the potentiometric pCO₂ sensor of the present invention;

FIG. 4 is another characteristic curve of the potentiometric pCO₂ sensor of the present invention; and,

FIG. 5 is another characteristic curve of the potentiometric pCO₂ sensor of the present invention.

### DESCRIPTION OF THE PREFERRED EMBODIMENTS

What is probed into the invention is a potentiometric pCO₂ sensor. Detail descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

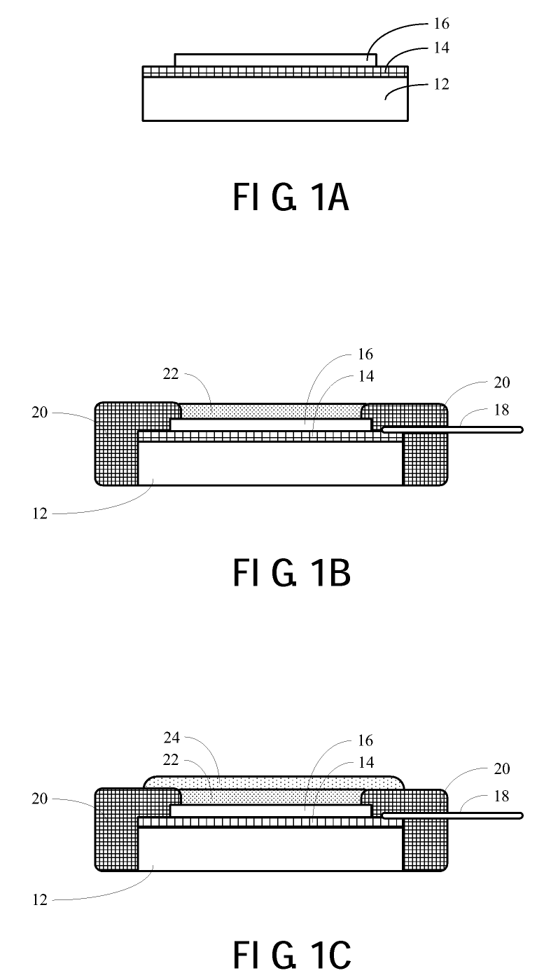

FIGS. 1A to 1C show schematic diagrams illustrating part of fabrication steps and sectional structure of the potentiometric pCO₂ sensor in a preferred embodiment of the present invention. At first, as shown in FIG. 1A, a solid ion-sensing layer 16 is deposited on a substrate (12 and 14) in which the substrate include a glass layer 12 and an indium tin oxide layer 14. In the embodiment, the preferred thickness of the indium tin oxide layer 14 is 230 Å. The solid ion-sensing layer 16 is formed by using tin dioxide (SnO₂) as the sputtering target and depositing on the substrate under the conditions that the temperature of the substrate is maintained at 150° C., the deposition pressure is 20 mtorr, and RF power is 50W. The preferred thickness of the solid ion-sensing layer 16 is 2000 Å. The substrate (12 and 14) can be replaced by an insulation substrate, such as ceramic substrate and glass substrate.

As shown in FIG. 1B, after the structure shown in FIG. 1A is made, a conducting wire 18 is connected to the solid ion-sensing layer 16 and a sealing process is performed to form a sealing layer 20 provided to enclose the peripheral of the substrate (12 and 14) and the solid ion-sensing layer 16 and cover the top thereof wherein the sealing layer 20 has a window to expose part of the solid ion-sensing layer 16. In the embodiment, the sealing layer 20 includes epoxy resin and the conducting wire 18 penetrates the sealing layer 20. The conducting wire 18 is adhered to the solid ion-sensing layer 16 by silver adhesive. Then, a solid electrolyte layer 22 is formed on the exposed portion of the solid ion-sensing layer 16. The method for forming the solid electrolyte layer 22 includes the following steps: providing 5 mM sodium bicarbonate (NaHCO₃) and 0.5 mM sodium chloride (NaCl) in deionized water (D. I. water) to form a first solution; adding 4 wt % of polyvinyl alcohol into the first solution to form a second solution; providing 10 mg/ml carbonic anhydrase into the second solution and stirring until turning uniform; and taking out 2 μl of the second solution and then dripping on the solid ion-sensing layer 16 in the window to stay still under room temperature for ca. 30˜60 minutes. In the embodiment, the area of the window is about 2*2 mm². The area of the window can be adjusted if necessary and is not limited to the example described in the embodiment.

As shown in FIG. 1C, after the structure shown in FIG. 1B is made, a gas-permeable layer 24 is formed on the solid electrolyte layer 22. The method for forming the gas-permeable layer 24 includes the following steps: dissolving 21.5 wt % bis(2-ethylhexyl)sebacate, 0.8 wt % valinomycin, and 77.7 wt % silicon rubber in tetrahydrofuran to form a third solution wherein every 100 mg of silicon rubber require 200 μl of tetrahydrofuran; and taking out 5 μl of the third solution and then dripping on the solid electrolyte layer 22 to stay still under room temperature for ca. 8 hours.

According to the above described method for fabricating the potentiometric pCO₂ sensor of the invention, the potentiometric pCO₂ sensor comprises: a substrate (12 and 14); a solid ion-sensing layer 16 on the substrate (12 and 14); a solid electrolyte layer 22 on the solid ion-sensing layer 16; and a gas-permeable layer 24 on the solid electrolyte layer 22; wherein the gas-permeable layer 24 allows air molecules to diffuse through, the pH value of the solid electrolyte layer 22 changes in response to the CO₂ concentration in the diffusing air molecules, and the solid ion-sensing layer 16 senses the pH change of the solid electrolyte layer 22 to generate a sensing signal. In the embodiment, the solid ion-sensing layer 16 includes tin dioxide (SnO₂) and has a preferred thickness of 2000 Å. The solid electrolyte layer 22 includes sodium bicarbonate (NaHCO₃), sodium chloride (NaCl), and polyvinyl alcohol (PVA). The gas-permeable layer 24 includes bis(2-ethylhexyl)sebacate, valinomycin, silicon rubber, and tetrahydrofuran. The potentiometric pCO₂ sensor further comprises a sealing layer 20 provided to enclose the peripheral of the substrate (12 and 14) and the solid ion-sensing layer 16 and cover the top thereof wherein the sealing layer 20 has a window to expose part of the solid ion-sensing layer 16. In the embodiment, the sealing layer 20 includes epoxy resin and has an area of 2*2 mm². The potentiometric pCO₂ sensor further comprises a conducting wire 18 connected to the solid ion-sensing layer 16 and penetrating the sealing layer 20 so as to output the sensing signal.

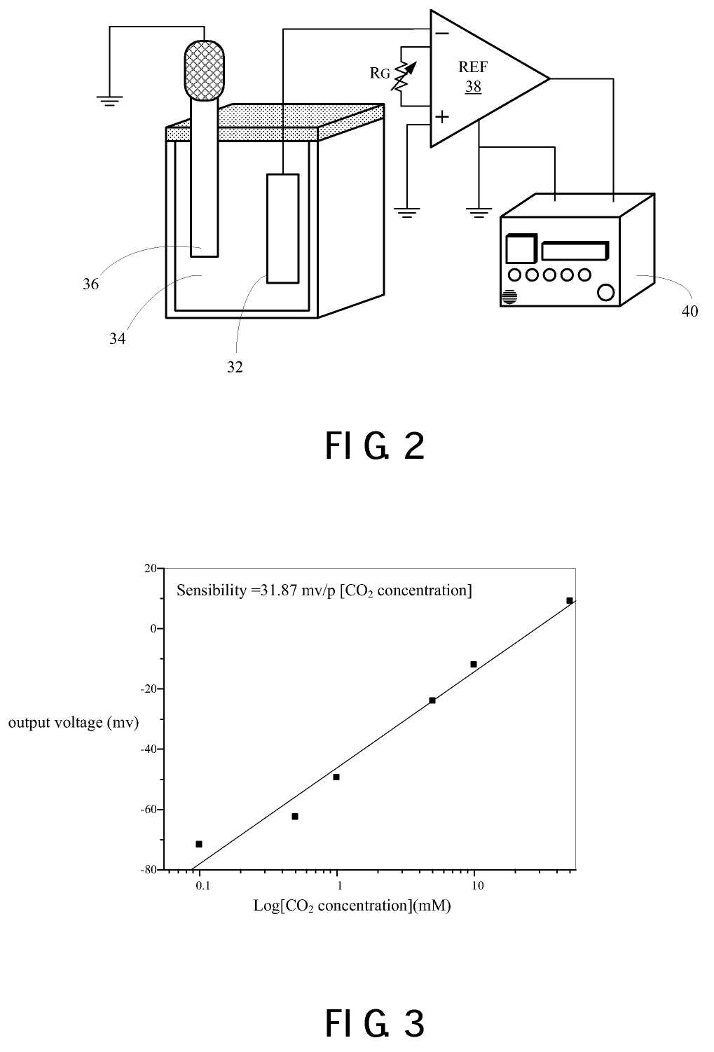

FIG. 2 shows a schematic system block diagram illustrating the measurement by the potentiometric pCO₂ sensor in a preferred embodiment of the present invention. The potentiometric pCO₂ sensor 32 has the structure shown in FIG. 1C and is provided in a liquid specimen 34 for detecting the CO₂ dissolution amount in the liquid specimen 34. One end of an electrode 36 is provided in the liquid specimen 34 and the other end of the electrode 36 is grounded so as to form a reference potential. An amplifier module 38 receives the sensing signal outputted from the potentiometric pCO₂ sensor 32 and the reference potential and then outputs an amplified signal to a processing and display module 40 to process and display the CO₂ dissolution amount in the liquid specimen 34. The amplifier module 38 can be an instrumentation amplifier and the processing and display module 40 can be a multifunctional digital electric meter.

FIG. 3 shows the measurement characteristic diagram of the potentiometric pCO₂ sensor in the CO₂ concentration detection range from 0.1 mM to 50 mM by using the system shown in FIG. 2.

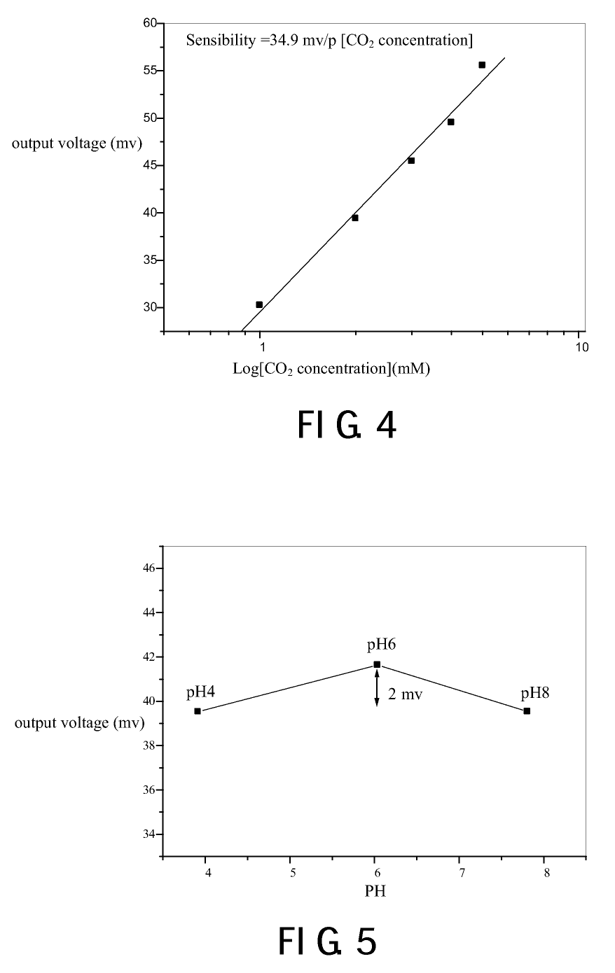

FIG. 4 shows the measurement characteristic diagram of the potentiometric pCO₂ sensor in the CO₂ concentration detection range from 1 mM to 5 mM by using the system shown in FIG. 2. The characteristic curve can be provided to calibrate the potentiometric pCO₂ sensor for those who skilled in the art so as to ensure the sensitivity of the sensor within a stable range.

FIG. 5 shows the measurement characteristic diagram of the potentiometric pCO₂ sensor under the environment with different pH values by using the system shown in FIG. 2. The effect of the different pH environments to the potentiometric pCO₂ sensor is observed as well as the effect of hydrogen ions and hydroxyl ions to the measurement of the potentiometric pCO₂ sensor. As shown in FIG. 5, the majority of the hydrogen ions and the hydroxyl ions in the solution do not significantly influence the potentiometric pCO₂ sensor of the invention. The voltage difference of the environments with pH4 and pH6 is only 2 mV. The voltage difference of the environments with pH6 and pH8 is only 2 mV. Therefore, the gas-permeable layer prevents the potentiometric pCO₂ sensor of the invention from disturbance.

It should be noted that FIGS. 3 to 5 show the examples of the present invention and do not restrict the scope of the invention.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A potentiometric pCO₂ sensor, comprising:
a substrate;
a solid ion-sensing layer on said substrate;
a solid electrolyte layer on said solid ion-sensing layer; and
a gas-permeable layer on said solid electrolyte layer;
wherein said gas-permeable layer allows air molecules to diffuse through, the pH value of said solid electrolyte layer changes in response to the CO₂ concentration in the diffusing air molecules, and said solid ion-sensing layer senses the pH change of said solid electrolyte layer to generate a sensing signal.

2. The potentiometric pCO₂ sensor according to claim 1, wherein said solid ion-sensing layer includes tin dioxide.

3. The potentiometric pCO₂ sensor according to claim 1, wherein the thickness of said solid ion-sensing layer is about 2000 Å.

4. The potentiometric pCO₂ sensor according to claim 1, wherein said solid electrolyte layer includes sodium bicarbonate, sodium chloride, and polyvinyl alcohol.

5. The potentiometric pCO₂ sensor according to claim 1, wherein said gas-permeable layer includes bis(2-ethylhexyl)sebacate, valinomycin, silicon rubber, and tetrahydrofuran.

6. The potentiometric pCO₂ sensor according to claim 1, further comprising a sealing layer provided to enclose the peripheral of said substrate and said solid ion-sensing layer and cover the top thereof wherein said sealing layer has a window to expose part of said solid ion-sensing layer.

7. The potentiometric pCO₂ sensor according to claim 6, wherein said sealing layer includes epoxy resin.

8. The potentiometric pCO₂ sensor according to claim 6, wherein the area of said window is about 2*2 mm².

9. The potentiometric pCO₂ sensor according to claim 1, further comprising a conducting wire for connecting with said solid ion-sensing layer to output the sensing signal.

10. A method for fabricating a potentiometric pCO₂ sensor, comprising:
depositing a solid ion-sensing layer on a substrate;
connecting a conducting wire to said solid ion-sensing layer;
performing a sealing process to form a sealing layer provided to enclose the peripheral of said substrate and said solid ion-sensing layer and cover the top of said substrate and said solid ion-sensing layer wherein said sealing layer has a window to expose part of said solid ion-sensing layer;
forming a solid electrolyte layer on said solid ion-sensing layer; and
forming a gas-permeable layer on said solid electrolyte layer;
wherein said gas-permeable layer allows air molecules to diffuse through, the pH value of said solid electrolyte layer changes in response to the CO₂ concentration in the diffusing air molecules, said solid ion-sensing layer senses the pH change of said solid electrolyte layer to generate a sensing signal, and the sensing signal is outputted by said conducting wire.

11. The method for fabricating a potentiometric pCO₂ sensor according to claim 10, wherein said solid ion-sensing layer is formed by using tin dioxide as the sputtering target and depositing on said substrate under the conditions that the temperature of said substrate is maintained at 150° C., the deposition pressure is 20 mtorr, and RF power is 50W.

12. The method for fabricating a potentiometric pCO₂ sensor according to claim 10, wherein the thickness of said solid ion-sensing layer is about 2000 Å.

13. The method for fabricating a potentiometric pCO₂ sensor according to claim 10, wherein said conducting wire is adhered to said solid ion-sensing layer by silver adhesive.

14. The method for fabricating a potentiometric pCO₂ sensor according to claim 10, wherein said sealing layer includes epoxy resin.

15. The method for fabricating a potentiometric pCO₂ sensor according to claim 10, wherein the area of said window is about 2*2 mm².

16. The method for fabricating a potentiometric pCO₂ sensor according to claim 10, wherein the method for forming said solid electrolyte layer includes the following steps:
providing 5 mM sodium bicarbonate and 0.5 mM sodium chloride in deionized water to form a first solution;
adding 4 wt % of polyvinyl alcohol into said first solution to form a second solution; and
taking out 2 μl of said second solution and then dripping on said solid ion-sensing layer in said window to stay still under room temperature for ca. 30˜60 minutes.

17. The method for fabricating a potentiometric pCO₂ sensor according to claim 10, wherein the method for forming said gas-permeable layer includes the following steps:
dissolving 21.5 wt % bis(2-ethylhexyl)sebacate, 0.8 wt % valinomycin, and 77.7 wt % silicon rubber in tetrahydrofuran to form a third solution wherein every 100 mg of silicon rubber require 200 μl of tetrahydrofuran; and
taking out 5 μl of said third solution and then dripping on said solid electrolyte layer to stay still under room temperature for ca. 8 hours.

18. A pCO₂ measurement method, comprising:
using a potentiometric pCO₂ sensor to detect the CO₂ dissolution amount in a liquid specimen wherein said potentiometric pCO₂ sensor uses a gas-permeable layer for allowing air molecules to diffuse through, a solid electrolyte layer changing the pH value thereof in response to the CO₂ concentration in the diffusing air molecules, a solid ion-sensing layer for sensing the pH change of said solid electrolyte layer to generate a sensing signal; and
providing one end of an electrode in said liquid specimen and grounding the other end of said electrode to have reference potential.

19. The pCO₂ measurement method according to claim 18, further comprising:
inputting the sensing signal and the reference potential into an instrumentation amplifier; and
inputting the output of said instrumentation amplifier into a processing and display module to process and display the CO₂ dissolution amount in the liquid specimen.
